(19) United States
(12) Patent Application Publication
(10) Pub. No.: US 2024/0066449 A1
(43) Pub. Date: Feb. 29, 2024

(54) BONDING MULTIPLE LAYERS OF FILTRATION MATERIAL

(71) Applicant: Andrew Industries Ltd., Altham (GB)

(72) Inventors: Alan Robert LEBOLD, Niagara Falls, NY (US); Jason Michael PALAZZO, Lockport, NY (US); Peter Francis GOERGEN, IV, Amherst, NY (US)

(21) Appl. No.: 18/239,336

(22) Filed: Aug. 29, 2023

Related U.S. Application Data
(60) Provisional application No. 63/434,482, filed on Dec. 22, 2022.
(60) Provisional application No. 63/401,822, filed on Aug. 29, 2022.

(51) Int. Cl. B01D 39/16; B01D 39/18; B01D 39/20

(52) U.S. Cl. CPC B01D 39/163; B01D 39/18; B01D 39/2017; B01D 2239/0622; B01D 2239/086; B01D 2239/1216; B01D 2239/1258; B01D 2257/10

(57) ABSTRACT

In some examples, a method includes bonding a multilayered filter medium comprised of at least one layer of filter membrane and at least one support layer web material by bonding along a perimeter of the filter web while concurrently slitting the multilayered filter medium. Further, some examples include a filter element comprising a multilayered filter medium with at least one first layer of a filter membrane or a meltblown material, and at least one support layer web material as a second layer, wherein the at least one first layer and the at least one second layer are bonded and sealed to each other along a perimeter thereof.

### CROSS-REFERENCES TO RELATED APPLICATIONS

This application claims the benefit of U.S. Provisional Patent Application No. 63/434,482, filed Dec. 22, 2022, and U.S. Provisional Patent Application No. 63/401,822, filed Aug. 29, 2022, both of which are incorporated by reference herein.

### BACKGROUND

Nonwoven textiles or fabrics are suited to use in the filtration industry, due to the nature of randomly distributed fibers creating a torturous path for filtered contaminants to navigate, to stay in the fluid stream passing beyond the filter element. These engineered textiles are comprised of properties such as material type, fiber shape, fiber size, thickness, weight, density, etc., which can be varied to achieve specific goals suited to their application. Where some filter mediums favor high tensile strength for durability, others may comprise fine fibers for high filtration efficiency.

It is common for a composite filter medium to be made of different layers, combining the strengths of the individual layers into one product. For instance, when filtering fluid containing contaminants of a large range of sizes, a filter element may include a pre-filter that may be positioned on the upstream side of the remaining filter layers to capture and retain larger contaminants. Subsequent layers may be configured to filter smaller contaminants. These layers are sometimes referred to as depth layers, containing regions capable of capturing particulate, without drastically reducing flow, obstructing the path of the fluid stream. Depth filter layers can be made from various materials such as polypropylene, polyester, aramids, or cellulose constructed into needlefelts, spunbonds, or meltblown webs.

One high-filter-efficiency material is expanded polytetrafluoroethylene (ePTFE) membrane. For instance, ePTFE membrane may be commonly found as the primary filter layer in HEPA grade filter elements because it can achieve fine contaminant filtration with an acceptable pressure drop across the filter. Additionally, ePTFE membrane may provide hydrophobic qualities and a low coefficient of friction, allowing consumers to easily remove foreign bodies from the membrane surface without excessive washing procedures. However, ePTFE membrane may be delicate and poses challenges from handling to processing. For example, pleating of filter elements may commonly cause tearing of the membrane layer at the apex of the pleat tips if not produced carefully.

Alternative membrane mediums may be used to achieve high efficiency filtration status. One example would include but is not limited to ultra-high molecular weight polyethylene (UPE) membranes, such as ARIOSO by LYDALL Inc. of Manchester, Connecticut, USA.

Meltblown nonwoven filter mediums are another common type of primary filter medium that is capable of high efficiency filtration. These mediums are comprised of synthetic fibers, which are extruded and randomly distributed through a process of blowing gas at high velocities across the extrusion nozzles. This method of forming a filter medium lends itself to use of fine fiber sizes, capable of fine filtration. This fine filtration comes with the drawback of the meltblown layer being easily pulled apart, like tissue paper.

By placing a membrane or meltblown layer (herein referred to as the primary filter layer) between support layers or depth filter layers, the primary layer may be protected and may be more easily handled without damage. However, in conventional filter systems where a primary layer is bonded with other materials to form filter elements, the bonded regions may significantly restrict the fluid flow through the filter elements, resulting in lower filter system performance. Further, conventional methods of adhering multiple layers may be performed by a textile supplier as a unique operation step, possibly prior to being provided to an external textile converter to make into an end product. Isolating processing steps can add significant labor costs, as opposed to performing a sequence of operations in series, or inline.

When combining multiple layers of filter material, there is an inherent risk of the layers delaminating through excessive handling or otherwise. Sintering of fibers aids in increasing the bond between layers. Sintering occurs when the fibers are heated to a point that they soften, but do not reach a liquidation temperature.

Multiple-layer filter medium may be converted into filter elements, such as a die cut filter or a pleated filter. A die cut filter, may be a flat sheet of filter medium, or it can be intricately cut into a defined shape with or without empty cavities inside the perimeter bounds of the filter. A pleated filter element may have a series of undulations folded to maximize the filtration surface area within a given volume of the filter element.

Material rigidity allows the pleated filter element to maintain its desired shape, with roughly uniform “V” shaped pleats. During use for filtration, pressure may build on the upstream side of the filter medium. If the filter medium is not rigid enough, the pleats can bow. When substantial bowing occurs between two adjacent pleats, the surfaces of adjacent faces may touch or come so close together that the flow path of the filtered fluid is limited to a region along the pleat tips of one side of the filter. To combat this loss of filter area and maintain proper pleat shape and spacing, glue beads of hot melt adhesive, may be applied in line along the surface of the pleated filter element.

### BRIEF DESCRIPTION OF THE DRAWINGS

FIG. 1 illustrates a cross-section of an example ultrasonically slit and bonded filter medium according to some implementations.

FIG. 2 illustrates an example apparatus and process for ultrasonically slitting and bonding multiple layers of material according to some implementations.

FIG. 3 illustrates an example of a pleated filter element according to some implementations.

FIG. 4 illustrates a cross-section of an example encapsulated pleated filter element according to some implementations.

FIG. 5 illustrates an example apparatus and process for laser slitting and bonding multiple layers of material according to some implementations.

FIG. 6 illustrates an example apparatus and process for hot knife slitting and bonding multiple layers of material according to some implementations.

FIG. 7 illustrates the cross-section of a pleating process, with heated platens and adhesive application.

FIG. 8 illustrates a pleated filter element comprised of multiple layers of filter materials, with additional glue beads to maintain the filter element shape.

FIG. 9 illustrates a heated steel rule die and filter element, comprised of multiple layers of filter material bonded along all edges.

### DETAILED DESCRIPTION

Some implementations herein include a bonded filter medium that may be usable as a filter element, or the like. For instance, the filter medium may include multiple layers of web (sheet) material, including a primary filter layer. The layers of web material may be bonded together in such a manner that the bonded areas do not obstruct the path of fluid flow.

Further, some examples herein are directed to techniques for concurrently cutting and sealing a primary filter layer sandwiched between outer layers of thermoplastic web material, such as through use of heated or ultrasonic slitting. The layers of thermoplastic web material may flow into one another at the slitting and bonding sites, creating a bond between the layers of thermoplastic web material along the perimeters of the thermoplastic web material and the primary filter layer, thereby encapsulating the primary filter layer between the layers of thermoplastic web material.

In some implementations, the bonding area is limited to the outermost regions of the filter medium's lateral extent, thereby allowing for the full extent of the medium's filtering area to be unencumbered by bonding agents. For instance, in conventional designs, regions bonded by densely packed thermoplastic or otherwise foreign adhesives cause an increase in pressure drop and may restrict fluid flow by as much as a factor of three. A filter element as described herein, without obstruction from bonding sites within the fluid path may include independent layers throughout the lateral extent of the filter, thereby decreasing pressure drop and providing optimal performance Thus, some examples include bonding multiple layers of material together to form a filter medium including a primary filter layer, which may be comprised of a membrane or a meltblown layer and without substantially reducing an area of the filter medium that is available for filtration. The multiple layers may be bonded along the edges of the filter medium concurrently with performing a process of slitting and/or trimming the width of the filter medium, and without obscuring the working filtration area of the filter medium between the bonded edges.

Producing a filter element, such as a pleated filter element, may include slitting a rolled sheet of multilayer filter medium to the appropriate size while concurrently bonding the edges of the filter medium as the filter medium enters the pleating equipment. Alternatively, in some cases, the filter medium may be rerolled and provided as a rolled good. Some examples herein may include positioning the slitting and bonding system in line with the pleating system to enable bonding of the multilayered filter medium composite to be performed concurrently with the slitting of the filter medium and subsequent pleating of the filter element. Thus, implementations herein may eliminate any need for point bonding or otherwise bonding the layers of the filter medium prior to the filter element production, thereby improving efficiency and achieving a cost savings through reduction in consumption of time and equipment resources.

Additionally, or alternatively, some examples may include positioning a membrane layer on an exterior upstream side of a composite filter medium, which may provide advantages in terms of washability of the filter medium. For instance, such a layer may be bonded along the lateral extents of the filter medium, as described previously, or may be heat laminated to the upstream side of a support layer comprised of a web of thermoplastic fibers. The low coefficient of friction and the hydrophobic nature of the membrane layer may allow for removal of foreign contaminants with relative ease, and without the need of replacing the filter.

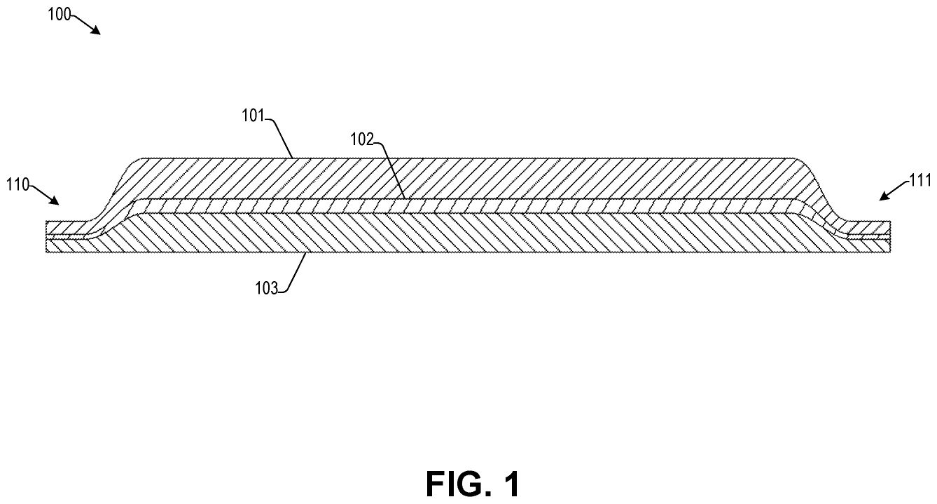

FIG. 1. shows a cross-section of an example of an ultrasonically slit and bonded multilayer filter medium according to some implementations. The relative thickness of these layers are not necessarily drawn to scale. The filter medium 100 in this example has two support material layers 101, 103 (e.g., thermoplastic web) and a primary filter layer 102. Along the outermost portion of either side of the lateral extent, the layers 101, 102, 103 are bonded together as indicated at perimeter edges 110 and 111. At all points between the bonded seams on either perimeter edge 110, 111 of the filter medium, layers 101, 102, 103 are unbonded and independent of one another.

With the layers 101, 102, 103 independent of each other, the filter medium 100 of FIG. 1 may achieve a fluid flow rate that is substantially improved as compared to a filter medium of the same layers 101, 102, 103, wherein the layers 101, 102, 103 have been bonded throughout the entire width of the filter medium or spot bonded at discrete locations across the lateral extent of the filter medium.

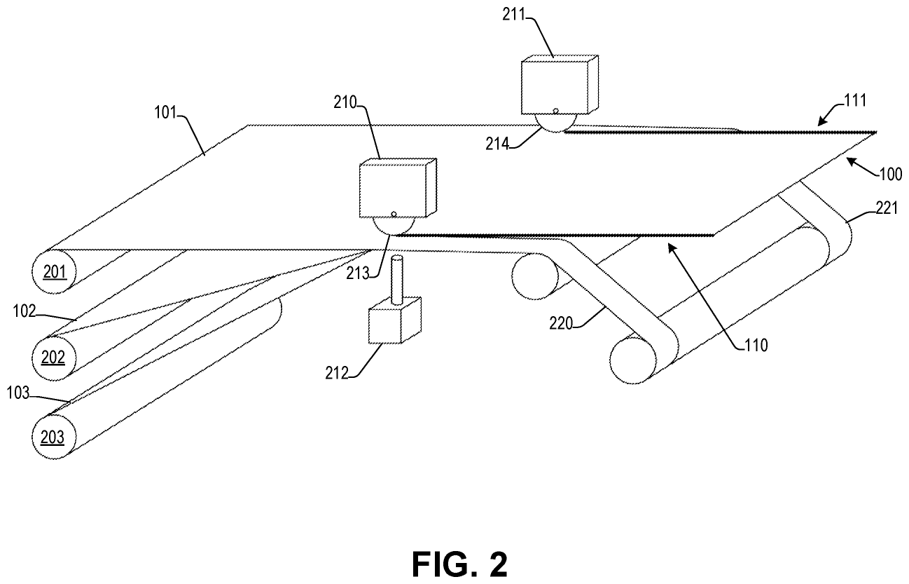

FIG. 2 illustrates an example apparatus and process for concurrent ultrasonic slitting and bonding a composite filter medium 100 having bonded areas only along the lateral perimeter edges 110, 111. Individual rolls 201, 202, 203 of webs of the support material layer 101, the primary filter layer 102, and the support material layer 103 are unwound and are positioned face-to-face adjacent to one another to form a multilayered composite with the respective material layers 101, 102, and 103 still being independent of one another as the webs of material are fed through the apparatus with the edges extending beyond the lateral positions of the ultrasonic slitting assemblies 210, 211.

Each ultrasonic slitting assembly 210, 211 may include an ultrasonic horn 212, and a rotating anvil 213, 214, respectively. As the energy applied by the horn 212 is transferred through the respective material layers 101, 102, 103 against the cutting anvil 213, 214, the support material layers 101, 103 may flow into one another, creating an ultrasonic or thermal bond at the perimeter edges 110, 111. Due to the narrow shape of the anvils 213, 214, the material is separated laterally 220, 100, 221 on either side of the anvil along the perimeter edges 110, 111.

Continuing along the web path, the filter medium comprised of multiple layers 101, 102, 103 is now a bonded composite filter medium 100, including at least one primary filter layer 102 (e.g., ePTFE, meltblown nonwoven), at least one support layer 101 (e.g., thermoplastic web) upstream of the primary filter layer 102, and may also include at least one support layer 103 (e.g., thermoplastic web) downstream of the primary filter layer 102. Additional thermoplastic layers and/or primary filter layers can be added to form a multi-layered composite with as many total layers as desired for the specific end application. The multilayer composite filter medium 100 may be bonded solely along the lateral perimeter edges 110, 111 of a width of the filter medium 100, leaving the multiple layers free and unbonded 101, 102, 103 at all points between these lateral edges 110, 111. Lacking any bonded regions in the fluid path of the filter medium 100, allows for a decreased pressure drop, thus improving the efficiency of the filter system. The excess material at 220, 221 may be removed from the web path, and may be recycled or discarded.

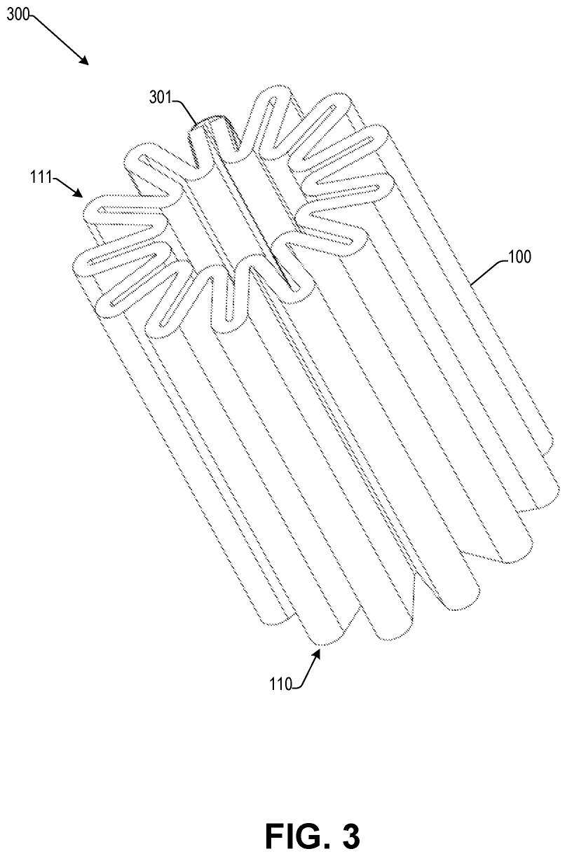

FIG. 3 illustrates an example filter element 300 according to some implementations. In this example, the filter element 300 is comprised of a multilayer composite medium 100 as described above, including at least one primary filter layer 102 (e.g., ePTFE, meltblown nonwoven), as well as at least one support layer 101 (e.g., thermoplastic web) upstream of the primary filter layer, and at least one support layer 103 (e.g., thermoplastic web) downstream of the primary filter layer. The filter medium 100 may be folded into an accordion-like shape by means of a pleater, such as may be obtained from JCEM Group GmbH of Fulenbach, Switzerland. With the bonded edges 110, 111, of the filter medium 100, bonded on either end of a continuous lane of pleated material, the filter element may be cut across the width of two pleat tips at a specified distance or number of pleats apart. These two pleat tips are brought together and mechanically fastened by means of a metal clip 301, giving the filter element 300 a generally cylindrical nature. Numerous other methods that can be used to fasten the end pleat tips together, such as ultrasonic or thermal welding, as will be apparent to those of skill in the art having the benefit of the disclosure herein. The path of fluid flow may be from the interior of the cylinder outward through the composite filter medium 100.

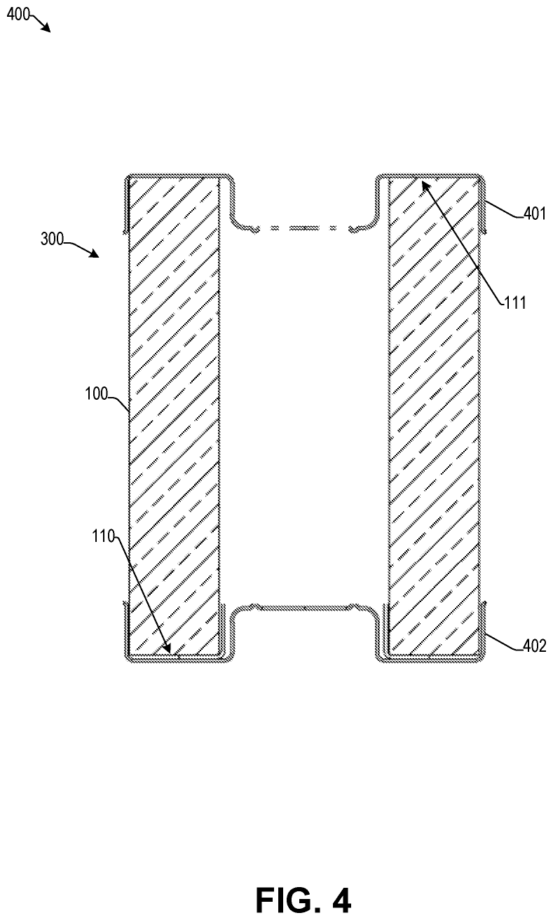

FIG. 4 illustrates a cross section of an example pleated filter assembly 400 according to some implementations. In this example, the pleated filter assembly includes the filter element 300 as discussed above with respect to FIG. 3, and which may include end caps 401, 402 on either end of the filter assembly 400. End caps 401, 402 may be applied to the filter assembly 400 through ultrasonics, which may include binding a thermoplastic into the lateral perimeter edges 110, 111 of the filter element 300. Alternatively, the end caps 401, 402 may be potted using a fluid multicomponent urethane or epoxy, which then hardens around the perimeter of the filter edges 110, 111, leaving the composite filter medium 100 exposed to the path of fluid flow between the end caps 401, 402. With the bonded edges 110, 111 of the filter medium 100 fully encased within said end caps 401, 402, outside of the path of fluid flow, there are no bonded materials present to hinder the path of fluid flow through the filter assembly 400.

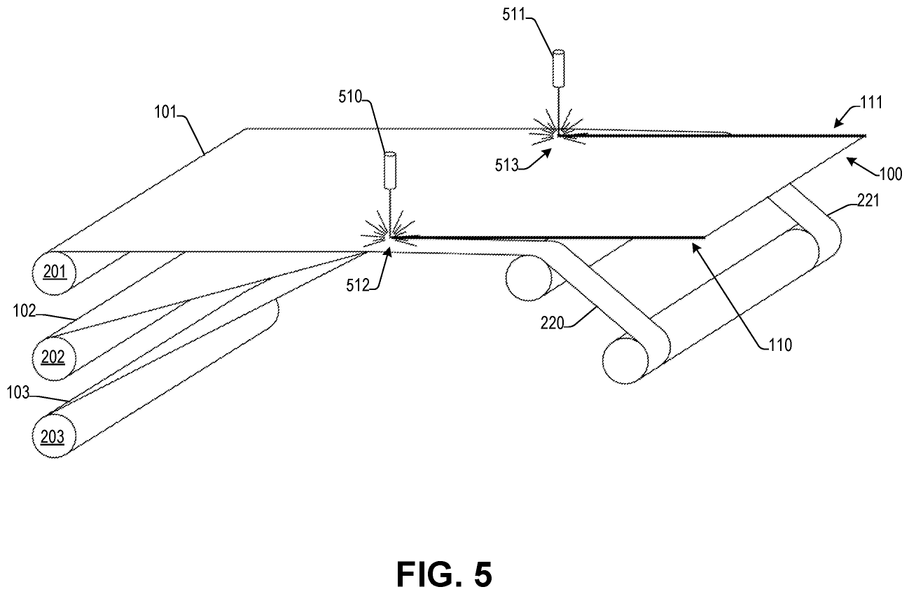

FIG. 5 illustrates an example apparatus and process for concurrent laser slitting and bonding a composite filter medium 100 having bonded areas only along the lateral perimeter edges 110, 111 in a process similar to the ultrasonic bonding process shown in FIG. 3. The webs of material 101, 102, 103 are fed through the apparatus with the edges extending beyond the lateral positions of the laser assemblies 510, 511.

Each laser slitting assembly 510, 511 is positioned to apply energy through the respective material layers 101, 102, 103 by means of a laser beam 512, 513, the support material layers 101, 103 may flow into one another, creating a thermal bond at the perimeter edges 110, 111. Similar to the process in FIG. 3, the material is separated laterally 220, 100, 221 on either side of the laser beams 512, 513 along the perimeter edges 110, 111.

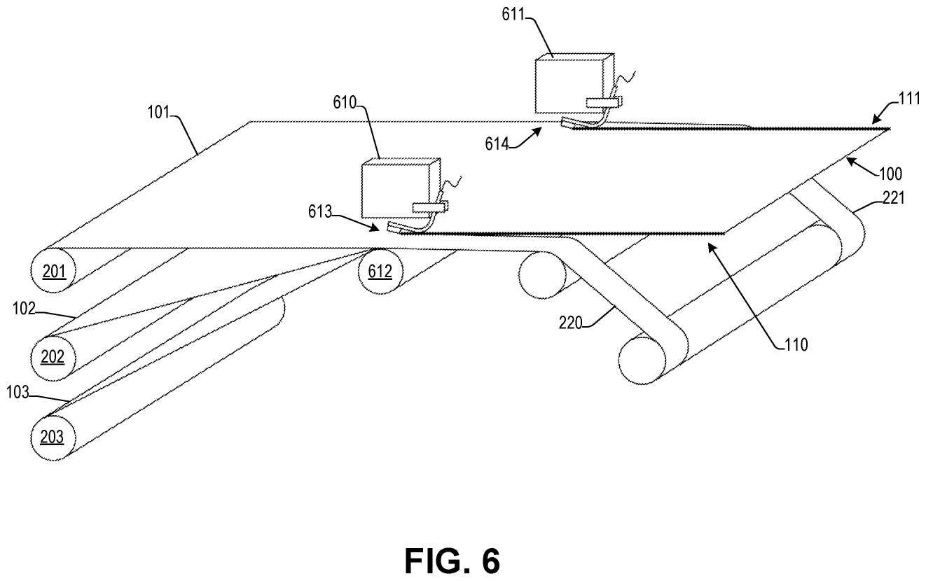

FIG. 6 illustrates an example apparatus and process for concurrent heat slitting and bonding a composite filter medium 100 having bonded areas only along the lateral perimeter edges 110, 111 in a process similar to the ultrasonic bonding process shown in FIG. 3. Material layers 101, 102, and 103 are fed through the apparatus with the edges extending beyond the lateral positions of the hot knife slitting assemblies 610, 611.

Each hot knife slitting assembly 610, 611 may include an anvil roller 612, and a heated knife element 613, 614, respectively. As the energy applied by the heated knives 613, 614 is transferred through the respective material layers 101, 102, 103 against the roller anvil 612, the support material layers 101, 103 may flow into one another, creating a thermal bond at the perimeter edges 110, 111.

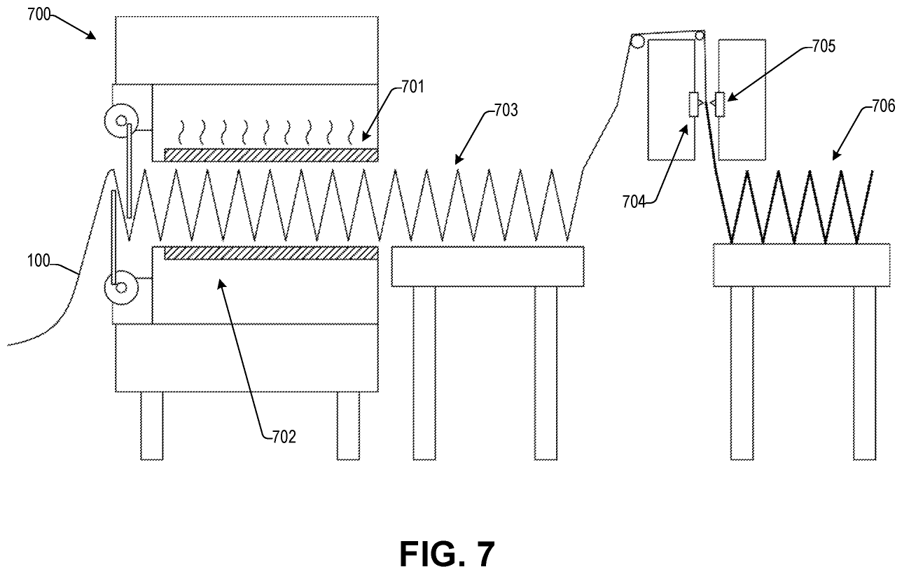

FIG. 7 illustrates the cross section of a pleating system 700, in which a multiple layer filter material, such as discussed above, may be processed. After the initial folds are introduced to the medium the material enters a region with a heated platen 701, 702 on either the top and or bottom of the pleated material. This heat activation causes a sintering or softening of the filter fibers, which will further set the shape of the pleated multiple layer filter material 703 after cooling. Dependent on the material processed, the process of pleating may not cause a restriction of the airflow compared to the unaltered filter media. The filter material may then travel through a piece of ancillary equipment such as a TAG Mini Pleater, which applies adhesive to either side of the material through adhesive application nozzles 704, 705. The adhesive may be applied in a plurality of lines across the width of the material. Once set, the adhesive provides additional strength and durability to the pleated media 706.

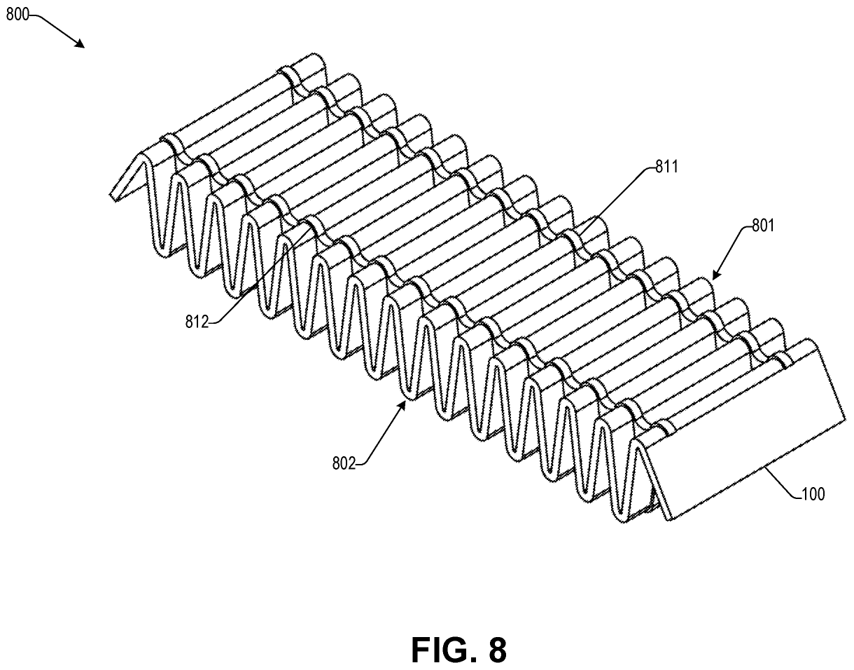

FIG. 8 shows a pleated filter element 800 that can be produced using the method and apparatus discuss above with respect to FIG. 7. The filter element 800 includes a multiple layer filter medium 100, which may or may not be ultrasonically welded along the edges 801, 802 of the pleat pack. Through the process of pleating, the filter material may be heated by one or more heated platens to set the shape of the filter element 800. This process provides the possibility of sintering individual layers of the filter medium, softening the fibers. Fibers of one layer in contact with fibers of adjacent layers may bond at the contact points through the mechanics of sintering as the material exits the platens and is allowed to cool, possibly requiring no additional bonding operations such as ultrasonically welding along the edge, nor any other conventional bonding process or agents. Bonding inline through means of operations already utilized to form the completed filter element, eliminates the need for additional processing steps, saving time, equipment, and resources.

Dependent on the material, some pleated filter elements 800, may have glue beads 811, 812 applied in lines along the length of the filter element 800. The conventional purpose of these glue beads 811, 812, is to maintain the shape and spacing between pleats, so that the filter performs its function maximizing the filter surface area and minimizing pressure drop across the filter element 800. These glue beads 811, 812 may have the added benefit in anchoring the individual layers of the filter element 800 together at desired intervals across the width of the filter. As the width of the filter medium increases, the flow pressure has an increasing force on the materials bonded. A buildup of foreign particulate may occur between individual layers, adversely constricting flow or increasing the pressure on discrete layers. Additional bond points, such as an increased number of glue beads 811, 812 may be employed to prevent delamination and optimize fluid flow.

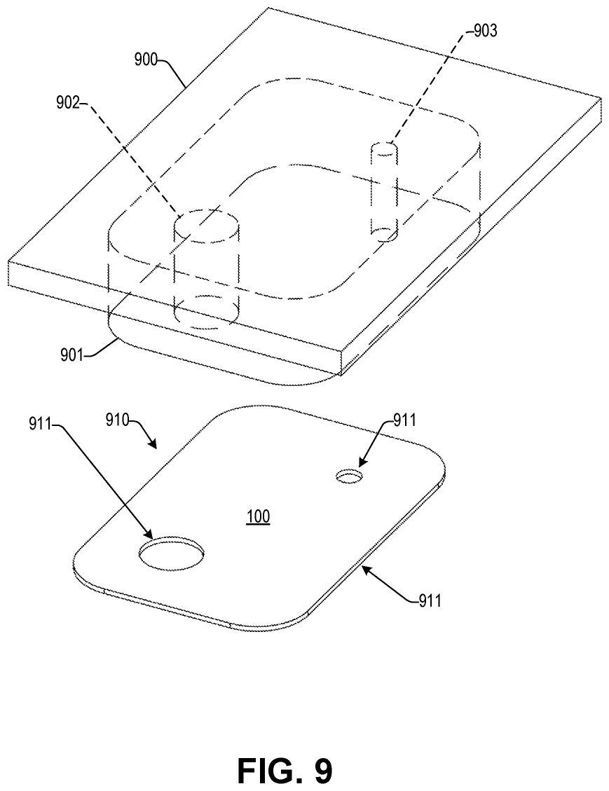

FIG. 9 illustrates a filter element 910 made from a multilayer filter medium 100, such as discussed above, which is sealed and bonded along all edges 911. The filter element 910 may be cut through use of a die board 900, comprised of heated steel rule 901 and heated punches 902, 903. Though FIG. 9 shows a heated steel rule die, the method of bonding the filter element 910 may alternatively include but is not limited to, ultrasonic die cutting, laser cutting, or steel rule die cutting with heated steel rule and/or punches.

What is claimed:

1. A method comprising:
bonding a multilayered filter medium comprised of at least one layer of filter membrane and at least one support layer web material by bonding along a perimeter of the filter web while concurrently slitting the filter medium.

2. The method as recited in claim 1, wherein the bonding utilizes ultrasonics.

3. The method as recited in claim 1, wherein the bonding utilizes laser cutting.

4. The method as recited in claim 1, wherein the bonding utilizes heated knives.

5. The method as recited in claim 1, wherein there are a plurality of the layers of the support layer web material comprising at least one of polyester, polypropylene, or other thermoplastic material.

6. The method as recited in claim 5, wherein the plurality of layers comprise at least one of spunbond material, spunlace material, needlefelted material, or meltblown material.

7. The method as recited in claim 1, wherein there are a plurality of the layers of the support layer web material comprising one or more of woven materials, nonwoven materials, or non-thermoplastic materials that are adhered to each other.

8. A filter element comprised of a multilayered filter medium as recited in claim 1, wherein the medium is assembled into an external casing with a perimeter of the medium encapsulated such that the perimeter is not in a direct stream of fluid flow.

9. The method as recited in claim 1, further comprising thermally bonding an ePTFE membrane layer to an upstream exterior of the multilayered filter medium.

10. The method as recited in claim 1, further comprising:
pleating the multilayered filter medium to form a pleated filter element; and
applying one or more glue beads across the pleated filter element to maintain pleats formed in the pleated filter element.

11. The method as recited in claim 10, further comprising:
forming the pleated filter element into a cylindrical shape;
applying a first end cap to a first end of the cylindrically shaped pleated filter element; and
applying a second end cap to a second end of the cylindrically shaped pleated filter element.

12. The method as recited in claim 11, further comprising sintering fibers of the at least one layer of filter membrane and the at least one support layer web material to each other via heat produced when creating the pleated filter element.

13. The method as recited in claim 1, wherein the multilayered filter medium includes at least one layer of meltblown material as the at least one layer of filter membrane, wherein the at least one support layer web material that is bonded along the perimeter of the multilayered filter medium while concurrently slitting the filter medium is bonded at least on two edges to the at least one layer of filter membrane.

14. A roll of the multilayered filter medium as recited in claim 1.

15. A filter medium comprised of at least one filter membrane and at least one thermoplastic web material, bonded only along the lateral extents at a time of slitting, and in which at least one ePTFE membrane is exposed as an outermost layer on an upstream side of the filter medium to enable washing.

16. A filter element comprising a multilayered filter medium with at least one first layer of a filter membrane or a meltblown material, and at least one support layer web material as a second layer, wherein the at least one first layer and the at least one second layer are bonded and sealed to each other along a perimeter thereof.

17. The filter element as recited in claim 16, wherein the at least one first layer and the at least one second layer are constructed of materials that are able to be bonded and sealed along the perimeter using ultrasonic energy.

18. The filter element as recited in claim 16, wherein the at least one first layer and the at least one second layer are constructed of materials that are able to be bonded and sealed along the perimeter using one or more lasers.

19. The filter element as recited in claim 16, wherein the at least one first layer and the at least one second layer are constructed of materials that are able to be bonded and sealed along the perimeter using one or more heated blades and/or a heated rule.

20. The filter element as recited in claim 16, wherein there are a plurality of the layers of the support layer web material comprising at least one of polyester, polypropylene, or other thermoplastic material.
